(19) United States
(12) Patent Application Publication
(10) Pub. No.: US 2023/0380329 A1
(43) Pub. Date: Nov. 30, 2023

(54) SYSTEMS AND METHODS FOR USE IN PLANTING SEEDS IN GROWING SPACES

(71) Applicant: CLIMATE LLC, Saint Louis, MO (US)

(72) Inventors: Lori BORDZUK, San Francisco, CA (US); Zoe HASKELL, San Leandro, CA (US); Nicholas P. OCHS, Ellisville, MO (US); Nick PONVERT, Seattle, WA (US); Nanchun SHI, Irvine, CA (US); Fletcher WERNER, Edwardsville, IL (US)

(21) Appl. No.: 18/202,250

(22) Filed: May 25, 2023

Related U.S. Application Data
(60) Provisional application No. 63/347,537, filed on May 31, 2022.

(51) Int. Cl. A01C 1/00

(52) U.S. Cl. CPC A01C 1/00

(57) ABSTRACT

Systems and methods are provided for identifying candidate seeds for a grower. An example computer-implemented method includes identifying multiple seeds for a grower suitable to be selected for planting in a growing space associated with the grower, and accessing data from a data server including seed data representative of each of the multiple seeds. The method also includes identifying candidate seeds from the multiple seeds for the grower, based on a model specific to the grower, wherein the model is trained on historical selections of the candidate seeds by the grower and/or at least one other grower in a region of said grower, independent of historical performance of the candidate seeds in the growing space. The method then includes outputting the identified candidate seeds to the grower and including, based on a selection by the grower, at least one seed from the identified candidate seeds in the growing space.

### CROSS-REFERENCE TO RELATED APPLICATION

This application claims the benefit of, and priority to, U.S. Provisional Application No. 63/347,537 filed on May 31, 2022. The entire disclosure of the above-referenced application is incorporated herein by reference.

### FIELD

The present disclosure generally relates to systems and methods for use in planting seeds in growing spaces and harvesting crops associated with the seeds.

### BACKGROUND

This section provides background information related to the present disclosure which is not necessarily prior art.

It is known for seeds to be grown in fields for commercial purposes, whereby the resulting plants, or parts thereof, are sold by the growers for business purposes and/or profit. For example, corn may be grown by a farmer in a field owned, leased, or managed by the farmer, and the corn grown and harvested from the field is then sold (e.g., for consumption by livestock, etc.). Consequently, farmers and other growers often seek to plant particular seeds based on specific aims of the farmers (e.g., corn versus soybeans, etc.), specific climate conditions (e.g., drought tolerance, etc.), disease resistance, and also, based on performance of the seeds in terms of yield. Farmers may rely on past performance of seeds in their fields, or on recommendations based on conditions of their fields, by seed providers, in selecting seeds for planting.

### SUMMARY

This section provides a general summary of the disclosure and is not a comprehensive disclosure of its full scope or all of its features.

Example embodiments of the present disclosure generally relate to computer-implemented methods for use in identifying candidate seeds. In one example embodiment, such a method for identifying candidate seeds generally includes identifying, by a computing device, multiple seeds for a grower, the multiple seeds suitable to be selected by the grower for planting in one or more growing spaces associated with the grower; accessing, by the computing device, data from a data server, the data including seed data representative of each of the multiple seeds; identifying, by the computing device, candidate seeds from the multiple seeds for the grower, based on a model specific to the grower, wherein the model is trained on historical selections of the candidate seeds by the grower and/or at least one other grower in a region of said grower, independent of historical performance of the candidate seeds in the one or more growing spaces associated with the grower; outputting, by the computing device, the identified candidate seeds to the grower and/or a user associated with the grower; and including, based on a selection by the grower, at least one seed from the identified candidate seeds in the one or more growing spaces.

Example embodiments of the present disclosure generally relate to systems for use in identifying candidate seeds. In one example embodiment, such a system for use in identifying candidate seeds generally includes at least one computing device configured to: identify multiple seeds for a grower, the multiple seeds suitable to be selected by the grower for planting in one or more growing spaces associated with the grower; access data from a data server, the data including seed data representative of each of the multiple seeds; identify candidate seeds from the multiple seeds for the grower, based on a model specific to the grower, wherein the model is trained on historical selections of the candidate seeds by the grower and/or at least one other grower in a region of said grower, independent of historical performance of the candidate seeds in the one or more growing spaces associated with the grower; output the identified candidate seeds to the grower or a user associated with the grower; and based on a selection of one(s) of the identified candidate seeds from the grower or the user associated with the grower, generate planting instructions for an agricultural planting apparatus, based on the selection of the one(s) of the identified candidate seeds, to plant the one(s) of the identified candidate seeds in the one or more growing spaces associated with the grower, whereby the agricultural planting apparatus operates to plant the one(s) of the identified candidate seeds in the growing space in response to the planting instructions.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for accessing data related to growing spaces and historical selection data from one or more growers, for use in identifying seeds for target fields;

FIG. 2 illustrates a section of an example seed catalog, for a specific example seed;

FIG. 3 illustrates an example data set across three different operations, in which planted and unplanted seed products are listed;

FIG. 4 illustrates an example diagram of features associated with selection of seeds by grower(s);

FIG. 5 illustrates an example method that may be used in the system of FIG. 1 to identify candidate seeds to growers;

FIGS. 6A-6B illustrate example logical organizations of sets of instructions in main memory of a computing device when an example application is loaded on the computing device for execution;

FIG. 7 illustrates a programmed process by which the system of FIG. 1 generates one or more preconfigured agronomic model(s) using agronomic data provided by one or more data source(s); and

FIG. 8 is a block diagram that illustrates a computing device (or computer system) upon which embodiments of the system of FIG. 1 and/or the method of FIG. 5 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Seeds to be planted in target fields (broadly, growing spaces) are selected by growers (broadly, users) based at least in part on the suitability of the seeds to the fields (or to one or more representative fields). Through years of growing selected seeds in the target fields, it may be apparent that performance of the seeds is not necessarily controlling in identifying candidate seeds for the one or more target fields in subsequent seasons. In this way, a higher performing seed may be replaced by growers, and a lesser performing seed may be retained, thereby suggesting unidentified factors, apart from performance, for example, often impact the growers' identification of candidates seeds for planting in the target fields in subsequent seasons.

Uniquely, the systems and methods herein provide for identifying candidate seeds for growers, for planting in target fields, based on associated factors of historical selections of seeds by the growers and others. In particular, an agricultural computer system accesses historical data for an example grower, and then compiles a data set indicative of the seeds planted by the grower and also the seeds available to the grower (yet not selected) (e.g., including identifiers for the seeds, characteristics for the seeds, indications of when or whether the seeds were planted/not planted, etc.). In connection therewith, historical data may comprise data relating to seeds planted by the grower in one or more years (e.g., year Y, year Y+1, etc.); and data related to unplanted seeds for the grower, based on the accessed data for the planted seeds; data for the planted and unplanted seeds can be joined in a training data set representing seed selection criteria specific to the grower. The data set (e.g., as a training data set, etc.) may then be used to train a model to identify which characteristics of the seeds, based on data accessible to the grower, is instructive of the grower's decision to not only select the seed, but importantly, to retain the seed for planting in subsequent years, generally, apart from yield or performance (which may be separately addressed in providing a recommendation to the grower). The trained model is then implemented to identify candidate seeds, which may be selected and then retained by the grower in future seasons, whereby the underlying or obscured selection criteria of the grower (e.g., specific to that grower, etc.), are implemented as part of the candidate identification for the grower. As such, the agricultural computer system is enabled to provide a more efficient identification of candidate seeds, which relies on more than performance, in a manner particular to the grower (or region in which the grower is location) (and potentially hidden preference(s) of the grower/region), to improve consistencies of the growers' seed selection.

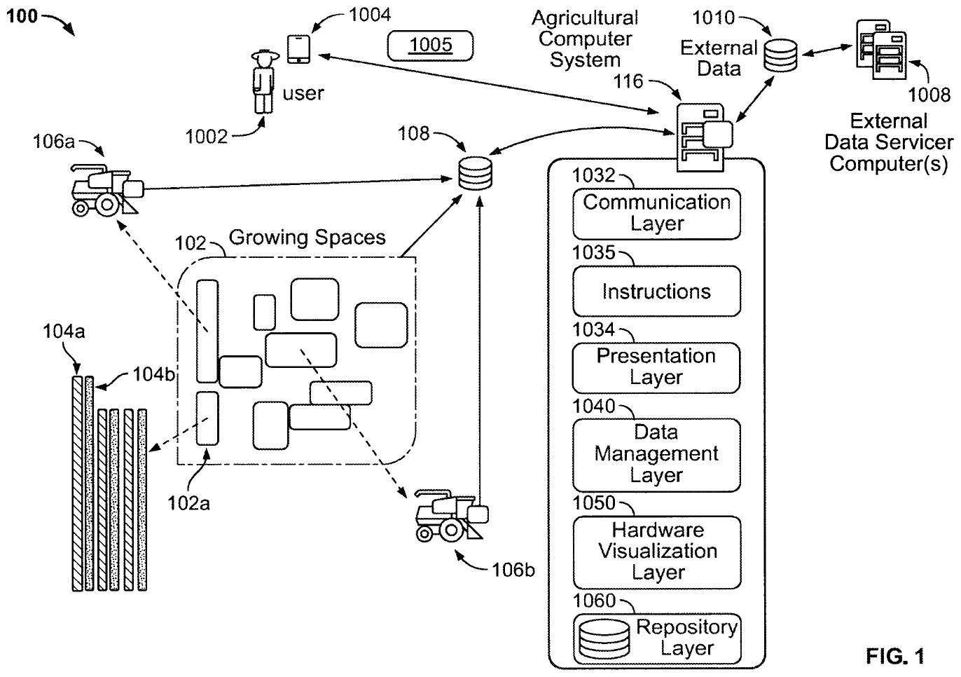

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users, farm equipment and fields; data flows; types of crops included in fields; types and/or locations of fields; planting and/or harvest activities; privacy and/or data requirements; etc.

As shown, the system 100 generally includes various growing spaces 102 (e.g., greenhouses, shade houses, nurseries, plots, fields, etc.), which (without limitation) are divisible into three specific types: research growing spaces, development growing spaces, and field growing spaces.

The research growing spaces are generally owned, managed and/or operated by one or more seed development entities, whereby different seeds are bred and then planted and grown in the research growing spaces. Numbers and/or types of seeds planted and grown in the research growing spaces will also vary depending on the type(s) of seed and/or the objectives of the research being conducted, etc. In connection therewith, the seeds are planted in specific fields and subjected to conditions (planned and/or unplanned) (e.g., irrigation, treatments, drought, etc.), and also measurements, whereby data is gathered related to the seeds and growth of the seeds, etc.

Similarly, the development growing spaces are often owned, managed, and/or operated by one or more seed development entities, whereby different seeds, often seeds previously included in the research growing spaces, are planted and grown in the development growing spaces. Often, but not always, the development growing spaces will include an increased population of seeds, but fewer varieties of seeds. In this manner, the development growing spaces provide for further experimentation for fewer seeds, fewer varieties of seeds, and/or different seeds, etc., as compared to the research growing spaces. Again, in connection therewith, the seeds are planted and subjected to conditions (planned and/or unplanned) (e.g., irrigation, treatments, droughts, etc.), and also measurements, whereby data is gathered related to the seeds and growth of the seeds in the development growing spaces, etc.

With continued reference to FIG. 1, field growing spaces are generally commercial fields, for which seeds are purchased by a grower (e.g., user 1002 associated with field 1005, etc.), grown in the fields (e.g., field 1005, etc.), and the crops resulting from the seeds in the fields are harvested and commercialized. The field growing spaces are often owned by farmers and/or grower entities in the business of growing, harvesting, and selling crops. In connection therewith, the farmers/growers may alter conditions of the field growing spaces, as the seeds grow into plants (e.g., through treatments, irrigation, etc.), and then harvest the crops with a variety of different farm equipment (e.g., combines, pickers, etc.). That said, in FIG. 1 the field 1005 associated with the user 1002 may be a field growing space herein (where the field 1005 may be considered one of the growing spaces 102, etc.).

In the illustrated system 100, one of growing spaces 102, which is referenced 102a, is illustrated in detail. The example growing space 102a includes, in this embodiment, six rows, of which a certain set of rows includes one variety of seed 104a and another set of rows includes a different variety of seed 104b. The different rows in the sets with the different varieties of seeds are each designated by different hatching in FIG. 1. Each of the different seeds 104a-b is planted “side-by-side” (broadly, split planting or in a split-planting configuration) and subject to substantially similar conditions (e.g., relative to different fields in the same region, etc.), whereby the data from the growing space 102a, for example, is generally indicative of relative performance of the seeds 104a-b. It should be appreciated that, despite this example, the number of rows/sets, types and/or varieties of seeds, along with the distribution of the same or different seeds, and the planting times of the seeds, may vary in other growing space examples.

As noted above, data (e.g., agronomic data, etc.) is gathered at or from the growing spaces 102. The data may be gathered manually, or automatically, for example, by farm equipment, etc. The data may include plant/seed identifiers, plant/seed types, planting dates, location data, field identifiers, soil conditions, plant performance (e.g., height, strength, yield, etc.) (e.g., at one or more regular or irregular interval(s), etc.), plant growth stages, treatments, weather conditions, and other suitable data to identify the seed/plant and/or a performance of the seed/plant, etc.

In addition to the growing spaces 102 in FIG. 1, the system 100 also includes a number of harvesting devices 106a-b, a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the harvesting devices 106a-b include a harvesting device 106a and a harvesting device 106b, each disposed in the field growing spaces 102. Nonetheless, it should be also appreciated that a different number and/or type of harvesting devices, which may be distributed differently among the different growing spaces, may be included in other system embodiments.

The harvesting devices 106a-b may include, for example, combines, pickers, or other mechanisms for harvesting plants/crops from the growing spaces 102 in FIG. 1. The harvesting devices 106a-b may be automated, or reliant, at least in part, on a human operator, etc. The harvesting devices 106a-b, in general, may be configured to remove a particular part of the plant grown from the planted seed (e.g., an ear of corn, beans from soybeans, grain from wheat, etc.), which is referred to herein as harvesting, and may perform operations including picking, threshing, cutting, reaping, gathering, etc. In connection therewith, the harvesting devices 106a-b are configured to compile data specific to the plant(s) being harvested and to the operation of harvesting of the plant(s), etc. The data may include, without limitation, yield, weight, moisture content, volume, flow, or other suitable data, etc. Moreover, in this example, the harvesting devices 106a-b may be configured to track their locations at given times, as they move through the growing spaces 102, as expressed in latitude/longitude or otherwise, and to correlate the locations to other data gathered/compiled by the harvesting devices 106a-b (e.g., permitting the data to be correlated to a specific plant and/or seed based on planting data for the harvested growing space, etc.).

Each of the harvesting devices 106a-b is further configured to transmit the gathered data to the data server 108, depending on the particular growing space(s) for which the data relates. That said, a different number of data servers 108 may be included in other system embodiments, with the different data servers 108 each being specific to certain ones (or more) of the growing spaces 102, or not.

The data server 108, in turn, is configured to store the received data in one or more data structures. In general, in this example embodiment, the data server 108 is configured to store the data by year (e.g., Year_Y−1, Year_Y, Year_Y+1, etc.), which corresponds to the different growing years (e.g., 2015, 2016, 2017, etc.) for the growing spaces 102 (and/or plots, fields, etc. within the growing spaces 102, etc.). Then, for each year, the data structure(s) of the data server 108 will include the data for each of the fields/growing spaces 102, seeds, harvested plants, etc. For example, for each field designation or identifier, the data structure(s) of the data server 108 may include an identifier for each seed planted in a field/growing space 102 in the given year, for brands for seeds, for relative maturity, for types of insect protection traits, for seed treatment years, for side-by-side or S×S designations, for positions/distributions of seeds in the growing space 102, for location definitions of or within the growing space 102, for acreage of the growing space 102, for populations of seeds planted in the growing space 102, for average yields and harvest grain moisture (e.g., based on location and seed products, etc.), etc. The data may also include soil conditions, field elevations, precipitation amounts, irrigation amounts, or any other data indicative of the growing conditions for the seeds/plants in the given growing space 102, etc. It should be appreciated that any available and/or desired data may be collected with regard to the plots, fields, etc., in the different growing spaces 102 and/or the seeds planted therein, and stored in the data server 108 (e.g., whereby at least some of such stored data may be subsequently used as historical data herein, etc.).

The data included in the data structure(s) of the data server 108 may be augmented with additional information about seeds from one or more other sources, including, for example, a category of the seeds (e.g., from a breeding pipeline provided to create new plants by crossing existing pools of parents, from a commercial pipeline provided to commercialize desired products and sell such products to consumers, etc.) (e.g., relative maturity, etc.), a product name, a trade name, a source name, etc.

In this example embodiment, the data includes an indicator, based on the data from the growing spaces 102, as to which seeds are planted in which of the growing spaces 102 (e.g., fields therein, etc.). The data may be known for all of the growing spaces 102, or a portion of the growing spaces 102, for each prior growing season, year (e.g., Year_Y−1, Year_Y, Year_Y+1, etc.), etc., and stored in the data server 108. Consequently, the data may be instructive of which seeds were not planted in the same growing spaces in different growing seasons. In particular, by combining the indicator in the data, with data indicative of the comparability of the different seeds, the agricultural computer system 116 may be programmed, or configured, to compile a data set indicative of planted and unplanted seeds for a given growing space 102, per year, season, or another suitable interval, etc.

Accordingly, it should be appreciated that the seeds planted in the different growing spaces 102 may be in (or associated with) different categories (or statuses or availabilities or maturities, etc.), for example, within a commercial or breeding pipeline, etc. ranging from introduction to a pipeline (e.g., category A, etc.), to currently present in the pipeline (e.g., category B (e.g., recently introduced, etc.), category C (e.g., long-term present, etc.), etc.), and to being removed from the pipeline (e.g., category D, etc.). Limited data, if any, will be included in the data server 108 for brand new or newly introduced seed products. For other seed products in other categories of seed products (e.g., where the seed products are currently active within a pipeline or are being removed (or have been removed) from a pipeline or are more mature, etc.), for example, additional data may be available for prior years.

Given the above, the agricultural computer system 116 is programmed, or configured, to access the data related to the growing spaces 102 from the data server 108, and to identify candidate seeds to be recommended to growers of particular target fields (within the growing spaces 102 or otherwise).

In connection with identifying candidate seeds, the agricultural computer system 116 is configured to employ a model (e.g., a linear model, or generalized linear mixed or random effect model, etc.), which ingests certain input data to identify the candidate seeds based on the input data. Prior to identifying the candidate seeds, then, the agricultural computer system 116 is configured to train the model.

In this example embodiment, the agricultural computer system 116 relies on the above accessed data for a number of historical years, such as, for example, three years, etc. The years are designated herein as Y, Y+1 and Y+2, which may include, for example, 2019, 2020, and 2021, etc. The accessed data for year Y is used to train the model (e.g., as training data, etc.), and then the data for years Y+1 and Y+2 may be used to verify results, output, etc. of the trained model. Alternatively, the accessed data for more than one year, or potentially, all three years (Y, Y+1, and Y+2) may be used to train the model (with or without subsequent validation, etc.). It should be further appreciated that the model is trained specific to a grower in this example, but may be specific to a region, group of growers, or other union of growers/regions likely to provide consistent decision criteria, in other examples. That said, in other example embodiments, the accessed data may include data for more than three years, for example, Y−2, Y−1, Y, Y+1, and Y+2. Here, then, the accessed data for years Y−2, Y−1, and Y may be used to train the model (e.g., as training data, etc.), and the data for years Y+1 and Y+2 may be used to verify or validate results, output, etc.

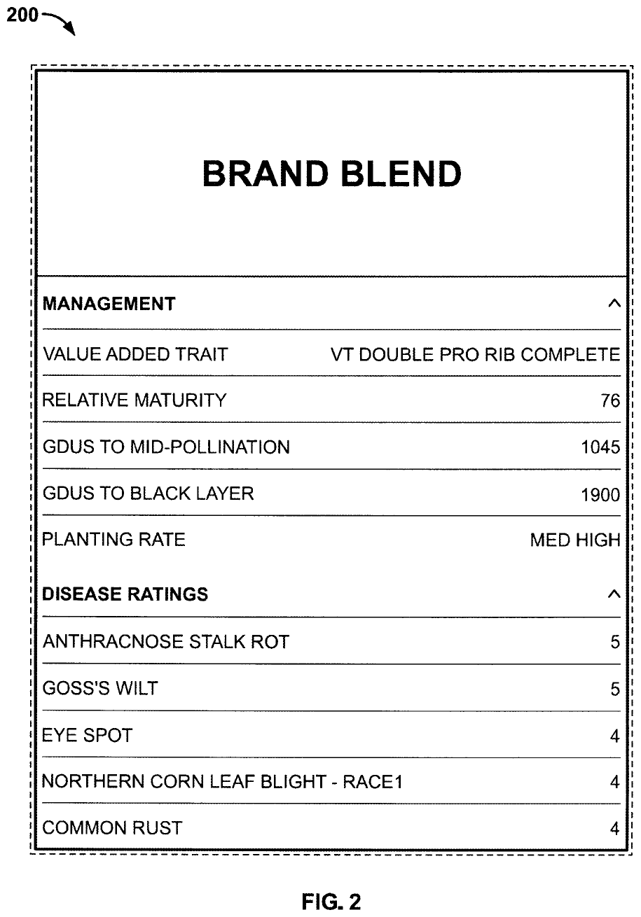

In connection therewith, in this example embodiment, the agricultural computer system 116 is configured to access the data for each of years Y, Y+1, and Y+2. The accessed data includes location data for a target field (broadly, a target growing space), or region (of fields, growing spaces, etc.), field conditions or classifications, etc., and also data specific to the seeds planted in the target field (or fields within the region, etc.), such as, for example, trade or commercial name, brand, product identifier, ratings, trait stack(s), product category (e.g., product age, etc.), relative maturity, stalk strength, wilt, green snap, leaf blight, dry down, harvest appearance, emergence, root strength, test weight, seeding growth, leaf spot, stalk rot, drought tolerance, etc., which may be indicated in a data sheet for the specific seed and/or based on performance of the seed in the target field(s) in one or more prior years. In general, for example, the accessed data for the seed may include any data published by a provider and/or seller of the seed (e.g., in datasheet, or in a seed catalog, etc.), whereby data that a grower considered in selecting the seed, or even data and/or information and/or products viewed in selecting a seed, is included. For example, FIG. 2 illustrates an example data publication 200 related to a specific field, whereby different data specific to the seed is listed. As shown in publication 200, the seed identified as Brand Blend is associated with a relative maturity of 76, a plant rating of med-high and Goss's wilt rating of 5, among other data. Despite the specific seed, and specific data, it should be appreciated that another datasheet for a seed may include the same or different information about the seed, etc.

In addition to the specific details of the seed itself, the accessed seed data also includes one or more indicators of the seed being planted in one or more fields associated with the grower, for a particular year, season, etc., which is referred to herein as previously planted seeds.

In addition, the accessed data includes like/similar/related unplanted seeds for the planted seeds, which may be identified based on availability and/or various characteristics of the seeds. For example, the agricultural computer system 116 may be configured to identify like, unplanted seeds based on a crop type, trait stack, relative maturity, product name, brand, or other suitable data associated with the seeds, whereby the seeds may be considered and/or designated as a potential seed option to be planted in the target field, etc. The data accessed about the like unplanted seeds is generally consistent with the type of data accessed for the planted seeds.

In various embodiments, the agricultural computer system 116 may be configured to access data (consistent with the above) for additional growers, for example, by region (e.g., country, postal code, zip code, territory, state, county, etc.). For example, where no historical planting data is known about the grower (e.g., no historical planting data for the grower is available in the data server 108, etc.), data from a region in which the grower is situated may be accessed (e.g., an average of other combinations of data associated with growers in that same region, etc.). That said, historical data for the grower may include accessible data known about the specific grower, about a region in which the target field is located and/or about multiple growers in that same region.

It should be understood that, in one or more embodiments, yield data for a target field, or various fields associated with the grower may be omitted, at this point, from the accessed data. That said, yield data may be included, in whole or in part, at this point in other embodiments.

After accessing the data, in this example embodiment, the agricultural computer system 116 is configured to standardize the accessed data. In particular, because the data may be input or entered by the specific grower, or otherwise input from sources apart from the agricultural computer system 116 (or associated computing devices), the data may refer to the same seed, for example, by different name, nomenclature, identifier, numbers, etc. (e.g., DKC26-40RIB versus Dekalb 26-40RIB, etc.), etc. As such, in one example, the agricultural computer system 116 may be configured to standardize the names associated with the seeds, so that seeds may be grouped together on the same standard name, or not.

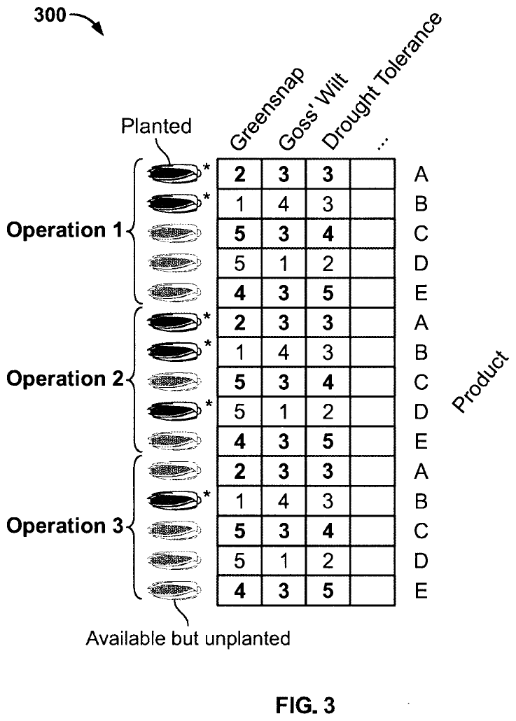

The agricultural computer system 116 is configured to then join the accessed data, which is specific to the grower, for the planted and unplanted seeds into a data set. The data set may include all, or a portion, of the accessed data, and further the indicator for planted or unplanted for each season, year, etc. FIG. 3 illustrates an example diagram representation 300 of the joined data, where each of multiple operations is specific to a grower, or a segment of the grower's fields, etc. The data set in the example representation 300 includes seed data in a matrix form with the features along the columns (e.g., Greensnap, Goss' Wilt, Drought Tolerance, etc.), and the seed product (e.g., A, B, C, D, E, etc.) for the rows, where the cells include numerical values for the feature and the seed. Here, the product names are A, B, C, D, and E, and the kernel symbol (e.g., asterisk or no asterisk, etc.) indicates whether the seed was planted as part of the operation (asterisk=planted, no asterisk=unplanted, as shown). This example data set then includes data for year Y (e.g., as a training year based on what was or was not actually planted, etc.), so that features in year Y, for example, may then be associated with adoption of certain seed in year Y+1, and retention (or not) of the certain seeds in year Y+2.

It should be appreciated that additional data may be included or constructed from the data included in the data set. For example, the agricultural computer system 116 may be configured to determine one or more stability metrics for the grower, operations, etc. The stability metric may be one or more combination of a minimum number of fields planted, or acreage, etc., and/or a consistency of the product names in the data as compared to one or more sources (e.g., a seed catalog, etc.). It should be appreciated that, in this manner, the stability metric provides an integrity check on the joined data to confirm a sufficient volume of data (likable to the catalog, for example) is available to train the model, to avoid, for example overfitting, skewed data, or also to permit sufficient validation, etc. In one example, the stability metric may require hundreds of acres (e.g., 100, 500, 700 acres, etc.), and/or over 50%, 60%, or 80% matching to catalog names, etc. Other stability metrics may be employed, by the agricultural computer system 116, depending on, for example, the type of model used, variability of data, etc.

Next, the agricultural computer system 116 is configured to train a model based on the joined data set for year Y, in this example (as a training data set), and in some embodiments potentially further on the results for adoption and retention (or not) of certain seeds. The model, which is a generalized linear mixed effects model, in this example, is provided in Equation (1) below, with the random intercepts expressed in Equation (2) and the random slopes expressed in Equation (3).

$$η = {c}_{op} + {\sum }_{features} {x}_{prod , feature} \cdot {w}_{op , feature} \qquad ( 1 )$$

$${c}_{op} = 𝒩 ( {μ}_{op} , {σ}_{c} ) \qquad ( 2 )$$

The η is per seed product, where cₒₚ is a feature agnostic probability of planting the seed with N as a normal distribution. In addition, x_{prod,feature} represents a known value associated with the given product for the given feature (e.g., a known resistance of a particular product to a disease based on product testing, etc.); w_{op,feat} represents a weight the model may apply to a specific feature when making predictions (for example as a latent random variable); μ_{op,feat} represents an estimate for the mean of w_{op,feat}; and σ_{feat} represents the model's estimate for the standard deviation of w_{op,feat}. With reference to Equation (1), the training is employed to determine the specific weights to be applied in connection with the different features included in the data set.

The probability per product (p) is mapped to a scale from 0 to 1, by Equation (4) below, and then, the seed is either identified or not (Y) (1 is identified, 0 is not) by Equation (5), as a function of the Bernoulli's distribution.

$$p = \frac{1}{1 + {e}^{- η}} \qquad ( 4 )$$

$$Y ∼ Bernoulli ( p ) \qquad ( 5 )$$

Training of the model is further based on variational inference, in this particular embodiment, whereby the agricultural computer system 116 is configured to leverage Equation (6), below. Equation (6) is based on a Bayesian theorem, observed variables X and latent variables Z, where X is observed on data set D (as compiled above). In addition, in Equation (6), the posterior is defined as P(Z|X=D), but a surrogate posterior q(Z), or approximation, is employed, where training makes the surrogate posterior close to the true posterior of the data, and where the training leverages the Kullback-Leiber (KL) divergence and evidence lower bound or ELBO.

$$KL ( q ( Z ) ‖ P ( Z \vert X = D ) ) = - 𝔼 [ log ( \frac{P ( Z , X = D )}{q ( Z )} ) ] + log ( P ( X = D ) ) \qquad ( 6 )$$

In Equation (6), the ELBO provides the first term and the log(P(X=D)) is a constant. The agricultural computer system 116 is configured to then train the model to maximize the ELBO, as a manner of minimizing the KL divergence to promote similarity between the true posterior and the surrogate posterior q(z). In connection therewith, the posterior P(Z|X=D) is approximated, for example, via variational inference. See, for example, Jordan, M. I., Ghahramani, Z., Jaakkola, T., and Saul, L. (1999): “Introduction to variational methods for graphical models,” Machine Learning, 37:183-233; and Wainwright, M. J. and Jordan, M. I. (2008): “Graphical models, exponential families, and variational inference,” Foundations and Trends in Machine Learning, 1 (1-2):1-305.

It should be appreciated that other specific expressions may be used to determine convergence and/or accuracy of the surrogate approximation, as needed, in other embodiments. That said, based on the specific training data compiled (i.e., a training data set thereof), the agricultural computer system 116 is configured to then train the model, and specifically the weights expressed in Equations (1) and (3). The weights are defined, through the training, as a value and a confidence. The agricultural computer system 116 is configured to store the weights and confidence in memory.

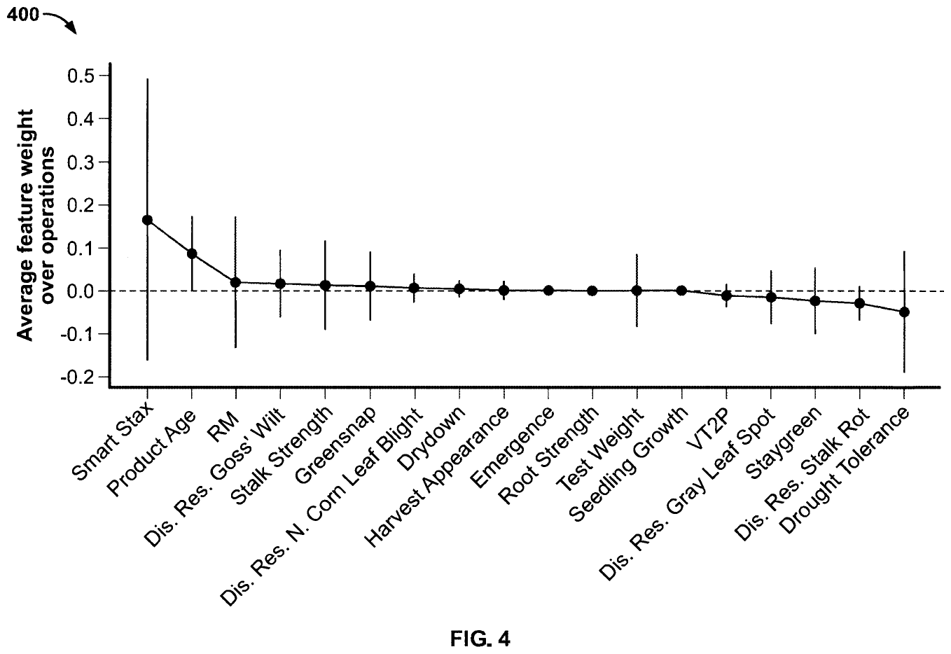

FIG. 4 illustrates an example diagram 400 of average feature weights over various growers, or operations. More particularly, the diagram 400, in this example, illustrates results of analysis (e.g., by the agricultural computer system 116, etc.) involving an average of feature weights across all of the learned weight vectors for growers within a particular geographic region. In doing so, the example diagram 400 provides average weights indicative across multiple growers for multiple different features. In various embodiments, the average weights may be generated per region, whereby the particular features identified in the diagram 400, for example, may indicate higher weighted features for the region. Further, the average weights may then be used where grower specific data is not known or not available. As such, in general, the example diagram 400 provides a regional indicator of features that may provide insight as to grower preferences at a larger scale.

In another example, the agricultural computer system 116 may be configured to train a model based on the joined data set for multiple years (e.g., year Y−1, year Y, etc.), or subsets thereof (e.g., defined segments of different years, etc.). This generally provides an extension of the above, with training based on more than one year (e.g., two years, three years, five years, ten years, etc.), whereby generally long-term consistent behaviors of growers may be taken into account (e.g., which may help recognize if a planted observation is something growers were trying new, or something they have been planting consistently for multiple years; etc.).

In this example embodiment, the model is provided in Equation (7) below, with the random intercepts expressed as in Equation (8) and the random slopes expressed in Equation (9) and Equation (10).

$$η = {c}_{op} + {\sum }_{features} {x}_{prod , feature , year} \cdot {w}_{op , feature} + {\sum }_{features} {x}_{prod , feature , year} \cdot {w}_{year , feature} \qquad ( 7 )$$

$${c}_{op} = ( {μ}_{op} , {σ}_{c} ) \qquad ( 8 )$$

$${w}_{op , feat} = ( {μ}_{op , feat} , {σ}_{feat} ) \qquad ( 9 )$$

$${w}_{year , feat} = ( {μ}_{year , feat} , {σ}_{year , feat} ) \qquad ( 10 )$$

Again, the η is per seed product, where cₒₚ is a feature agnostic probability of planting the seed with N as a normal distribution. In addition, x_{prod,feature,year} represents a known value associated with the given product for the given feature in the given crop year (e.g., a known resistance of a particular product to a disease based on product testing, etc.); W_{year,feat} represents a weight the model may apply to a specific feature for the crop year when making predictions (for example as a latent random variable); μ_{op,feat} represents an estimate for the mean of w_{op,feat}; and σ_{feat} represents the model's estimate for the standard deviation of w_{op,feat}.

Then as above, the probability per product (p) is mapped to a scale from 0 to 1, by Equation (4), and the seed is either identified or not (Y) (1 is identified, 0 is not identified) by Equation (5), as a function of the Bernoulli's distribution. And, as also above, training of the model is further based on variational inference, in this particular embodiment, whereby the agricultural computer system 116 is configured to leverage Equation (6).

With further reference to FIG. 1, as described above, the compiled data set includes training data (e.g., a training data set, etc.) that may include the data from year Y as well as the data from year Y−1. That said, it should be appreciated that additional data in the compiled data set for one or more additional years may also be used as training data (e.g., such that the training data set includes training data for multiple years, etc.). In addition, it should be appreciated that the compiled data set may include the training data set as used/discussed above, and then a validation data set for validation of the trained model (based on the year Y data, based on other year data, etc.). In such instances, the training of the model may be considered validated (or verified) when the performance of the model in identifying candidate seeds is above, or otherwise satisfies, a suitable defined threshold (e.g., based on data for year Y+1, year Y+2, etc.). The threshold may define, for example, a desired percentage of seeds actually selected and/or adopted by the grower(s) (e.g., in year Y+1, etc.), and/or a desired percentage of adopted recommended seeds actually retained by the grower(s) (e.g., in year Y+2, etc.). In connection therewith, in some embodiments, the defined threshold may be determined, established, defined, etc. by running the trained model on historical data (e.g., in year Y−1, year Y−2, Y−3, etc.) to identify percentages of recommended seeds actually selected, to identify percentages of recommended seeds actually retained in subsequent years, etc., whereby the threshold is then based on (or takes into account) such percentages. It should be appreciated that the defined threshold may vary, for example, depending on geography, type of seed/crop, filed size, etc.

In some example embodiments, validation of the model may be based on data from multiple different years (e.g., year Y−1, year Y−2, year Y+1, year Y+2, etc.). In such examples, validation may take into account seeds recommended by the model that were actually adopted, retained, etc. Further, the model may be updated, revalidated, etc. based on subsequent years (e.g., year Y+1, year Y+2, etc.), as desired, so that the agricultural computer system 116 is permitted to validate, verify, etc. the model over time, for the known data set(s).

With such validation, the agricultural computer system 116, in general, has validated the above model and sequence for training the model. For use then, the trained model is employed, based on input data from a current, or prior, year, i.e., mostly recent year (or years) in this example embodiment.

In particular, in this example embodiment, a user selects a target field and/or a grower, for which or by which candidate seeds are to be identified. The agricultural computer system 116 is programmed, or configured, to present one or more interface(s) to the user, or otherwise permit the user to provide an input requesting the identification of candidate seeds for the grower. The user may be the grower, or the user may include a representative of a seed provider or distributor, on behalf of the grower. The agricultural computer system 116 is configured to then access data for the grower, from the data server 102.

Consistent with the above, generally, the accessed data for use in identifying candidate seeds includes location data for the target field, or the region of the grower/field, field conditions or classifications, etc., and also data specific to the seeds planted in the field(s) (in the most recent year(s) or other years, as selected), such as, for example, trade or commercial name, brand, product identifier, ratings, trait stack(s), product category (e.g., product age, etc.), relative maturity, stalk strength, wilt, green snap, leaf blight, dry down, harvest appearance, emergence, root strength, test weight, seeding growth, leaf spot, stalk rot, drought tolerance, etc., which may be indicated in a data sheet for the specific seeds. In general, as above, for example, the accessed data for the seeds may include any data published by a provider and/or distributor of the seeds (e.g., in datasheet, or in a seed catalog, etc.), whereby data that a grower considered in selecting the seeds, or even views in selecting seeds, is included. In addition, similar to the above, the agricultural computer system 116 identifies like, unplanted seeds based on a crop type, trait stack, relative maturity, product name, brand, or other suitable data associated with the seeds, whereby the seeds may be considered and/or designated as potential seeds to be planted in the target field, etc. The data accessed about the like unplanted seeds is generally consistent with the type of data accessed for the planted seeds.

After accessing the data, in this example embodiment, the agricultural computer system 116 is configured to standardize the accessed data. In particular, because the data may be input or entered by the specific grower, or otherwise input from sources apart from the agricultural computer system 116 (or associated computing devices), the data may refer to the same seeds, for example, by different names, nomenclature, identifiers, numbers, etc. As such, in one example, similar to the above when training the model, the agricultural computer system 116 may be configured to standardize the names associated with the seeds, so that seeds may be grouped together on the same standard name, or not.

Next, the agricultural computer system 116 is configured to access the model and the weights and confidences, and then to determine the probability of each of the seeds in the data set as being adopted and retained, through the model of Equations (1)-(5) or through the model of Equations (7)-(10), as trained (i.e., with the weights and confidences determined above). The output includes a listing of the seeds included in the data set, and also a probability associated therewith. In addition, in the illustrated embodiment, as a Bayesian model is implemented, the output may further include a distribution over potential probability values for the seeds (e.g., a predicted probability and a confidence interval around that prediction, etc.).

It should be appreciated that the identified candidate seeds may then be further processed or compared with other seeds. For example, the agricultural computer system 116 may be configured to assess the directed head-to-head performance, based on yield, for example, between various seeds, such as, for example, described in Applicant's U.S. application Ser. No. 17/824,845 filed May 25, 2022. The output of the performance assessment may be combined in one manner or another to then selected candidate seeds to recommend and/or identify to the grower.

With continued reference to FIG. 1, in this example embodiment, the agricultural computer system 116 is also programmed, or configured, to output the identified candidate seeds to the grower (e.g., the user 1002 in FIG. 1, etc.). The candidate seeds may be provided in a table, in which the probabilities are included or may be included in an interface along with a reasoning. In particular, in this example embodiment, the model is permitted to identify one or more significant factors in identifying the candidate seeds. The factor(s) may then be provided to the grower along with the candidate seeds.

One (or more) seed(s) from the set of candidate seeds is then selected, by the grower/user (e.g., by the user 1002 in FIG. 1, etc.). This may include the grower/user ordering and/or purchasing the selected candidate seeds, for instance, via the agricultural computer system 116, etc. (e.g., whereby the agricultural computer system 116 receives the order, purchase request, etc. from the grower/user, in response to output of the candidate seeds to the grower/user and a corresponding selection by the grower/user; etc.), and then the agricultural computer system 116 directing the selected seeds to the grower/user (e.g., delivering the selected seeds to the target field, etc.). In addition, the selected candidate seeds may be planted, by the grower/user or other party, for example, in the target field. In doing so, broadly, the selected candidate seeds are included (e.g., planted, etc.) in the target field, based on the selection described above. This may include the grower/user receiving the selected candidate seeds and operating a planter (or planting machine) to plant the seeds. Alternatively, this may include the agricultural computer system 116 generating planting instructions based on the selected candidate seeds and providing the instructions to a planter whereby the planter operates, in response to the instructions, to plant the selected candidate seeds in the target field (e.g., upon delivery of the selected seeds to the planter, etc.). In one or more embodiments, an agricultural machine (e.g., a planter, etc.) in the target field may be controlled automatically, through one or more scripts generated, by the agricultural computer system 116, in response to the user's selection and/or the identification by the agricultural computer system 116.

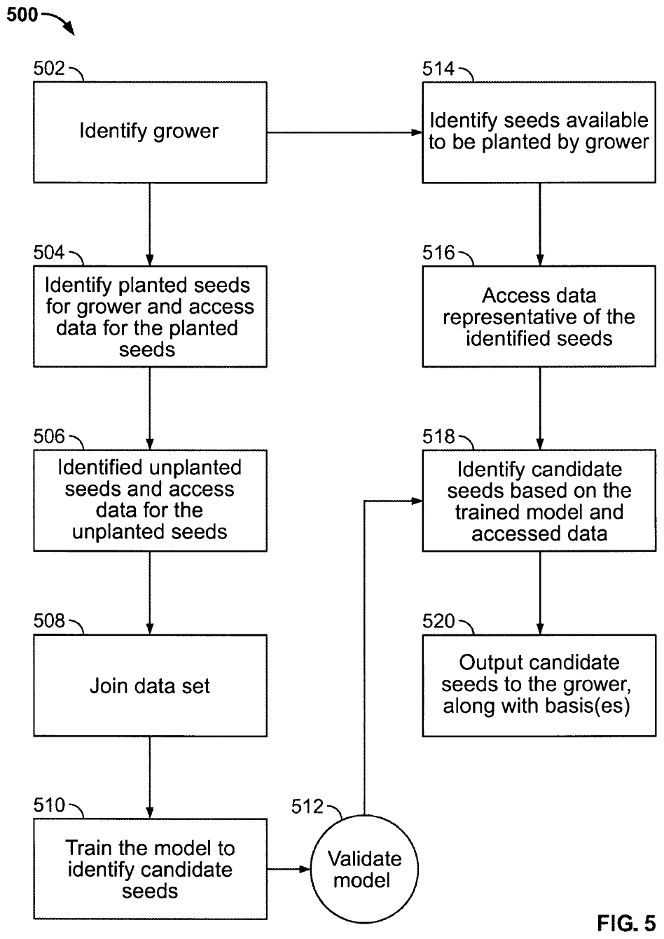

FIG. 5 illustrates an example method 500 for identifying candidate seeds. The example method 500 is described herein in connection with the system 100, and may be implemented, in whole or in part, in the agricultural computer system 116 of the system 100. However, it should be appreciated that the method 500, or other methods described herein, are not limited to the system 100 or the agricultural computer system 116. And, conversely, the systems, data structures, and the computing devices described herein are not limited to the example method 500.

At the outset, in method 500, a user identifies, at 502, a specific grower, for which a model is to be trained and candidate seeds are to be identified (e.g., the user 1002 in FIG. 1, etc.). The user may be the grower, or the user may be a sales representative or distributor of seeds, etc. In particular, for example, in connection with a recommendation of seeds to the grower, a sale representative may access the agricultural computer system 116, and request a recommendation of seeds, where the agricultural computer system 116 is configured to proceed as described herein. In connection therewith, the user may identify the grower by name, account number, location, etc., whereby the agricultural computer system 116 retrieves available identifying information for the grower, including, for example, identifying information for all the fields associated with the grower (e.g., fields for which the grower makes decisions, etc.), fields by number, and/or fields description, etc.

It should be appreciated that the recommendation may seek to identify candidate seeds for a specific target field, multiple target fields, or all the fields associated with the grower. In addition, the input from the user may include a specific desired type of seed to be identified and/or planted (e.g., corn, soybeans, etc.).

At 504, the agricultural computer system 116 identifies the planted and unplanted seeds for the grower. In particular, the agricultural computer system 116 access the historical data for the grower and identifies each of the seeds planted by the grower for a number of years. In this example, the agricultural computer system 116 accesses a most recent three years of data, which are designated Y, Y+1, and Y+2 (with Y+2 being the most recent). That said, it should be appreciated that the agricultural computer system 116 may access more data in other embodiments, for example, for more than three years (e.g., four years, five years, ten years, etc.), all available data, etc.

Additionally, at 504, the agricultural computer system 116 accesses data for the identified planted seeds. The accessed data may include any data about the seeds. That said, the accessed data includes specific data accessible to the grower, which informed the grower when the seeds were selected. For example, the accessed data may include a seed datasheet, or seed catalog entry for the seeds including various data about the seeds, as illustrated, for example, in FIG. 2. In at least one embodiment, the accessed data may be limited to data accessible to the grower, to thereby limit the training of the model below to the data known to the grower.

In addition, the agricultural computer system 116 optionally may clean the accessed data, including, specifically, data entered by the grower. For example, the grower may select and/or enter data into the grower's profile (e.g., through the CLIMATE FIELDVIEW application, etc.), whereby the data may be entered inconsistent with one or more standards. As such, the seed name or designator, for example, may be generally correct, but inconsistent with a standard name known to the agricultural computer system 116. As such, the agricultural computer system 116 may standardize the data, such as, for example, the seed designator, to promote the accessing of the appropriate data, at 504.

It should be appreciated that while the planted seeds are identified, and data accessed, based on the specific grower above, other grower(s) may be employed in other embodiments. For example, when a grower lacks historical planting data, or even sufficient historical planting data, the agricultural computer system 116 may identify multiple growers similar to the grower, for example, by location, region, operations, field characteristics, etc., and then identify planted seeds for the grower based on the planted seeds for the multiple growers, and proceed in method 500 accordingly.

After the planted seeds are identified, the agricultural computer system 116 identifies unplanted seeds for the grower, but were not selected by the grower, at 506 (e.g., seeds not selected/grown by the grower in the current year or in the current two years, current three years, etc.). The identified unplanted seeds may be recognized equivalents, or competing seeds, or may be identified based on one or more characteristics of the planted seed (e.g., relative maturity, draught tolerance, etc.), specifically or by a range, or may include seeds available to the grower in the given region of the grower, etc. Additionally, or alternatively, the identified unplanted seed may include all seeds of the same type as the planted seeds (e.g., corn, soybean, etc.), which are suitable to be planted in the fields associated with the grower (e.g., by relative maturity, by region, etc.). Again, as part of 506, the agricultural computer system 116 accesses data for the identified unplanted seeds. The data again may be any data related to the unplanted seeds, or, again, the accessed data for the unplanted seeds may be limited to data accessible to the grower, which informed the grower when the seeds were selected.

It should be appreciated that in steps 504 and 506 the accessed data is to be employed to train the model below, whereby the agricultural computer system 116 may limit the data included therein. That said, in identifying the planted and/or unplanted seeds, the agricultural computer system 116 may rely on additional data, which is not included as part of the accessed data.

With continued reference to FIG. 5, at 508, the agricultural computer system 116 joins the access data for the identified seeds, planted and unplanted, into a data set. In connection therewith, the agricultural computer system 116 may process the data. For example, the agricultural computer system 116 may separate the joined data set into training and validation sub-sets, whereby the data set for year Y is split. Also, the agricultural computer system 116 may format the data set as desired or required for the specific model to be trained. Additionally, as part of processing the data, the agricultural computer system 116 may utilize (or implement, or cause, or perform) a feature scaling operation on the data in the joined data set (or in the training sub-set and/or in the validation sub-set). For instance, the agricultural computer system 116 may subtract a mean value of the data and divide by a standard deviation. In doing so, all features may then have a similar variance and may be centered around zero, which may help with training the model and interpreting the learned weights.

Thereafter, at 510, the agricultural computer system 116 trains the model based on the data set, to identify candidate seeds for the grower. In doing so, the agricultural computer system 116 determines the specific weights and confidences of the weights, based on the grower's selections of seeds in year Y. The training is described in more detail above. At 512, the agricultural computer system 116 validates the trained model. In particular, in this example, the agricultural computer system 116 applies the validation data sub-set from year Y to identify candidate seeds, and then determines which of the identified candidates seeds where actually planted. In some embodiments, this may also include verifying results of the selection based on data for recommended seeds actually selected/adopted in year Y+1, year Y+2, etc., and further based on data for recommended seeds actually retained. In general, the training of the model is considered validated or verified when the performance of the model in identifying candidate seeds is within a defined threshold of recommended seeds actually selected/adopted, and/or is within a defined threshold of recommended seeds that are actually retained.

Once the model is trained, the method 500 returns to step 502, at which the grower is identified (e.g., once the model is trained apart from a recommendation request, etc.), or the method 500 proceeds with the identification of the grower, as already provided.

At 514, the agricultural computer system 116 identifies seeds, which are suitable to be potential candidate seeds to be planted by the grower. The unplanted seeds, in general, include seeds of the same type as the planted seeds (e.g., corn versus soybeans, etc.). and may include other similar features or characteristics. For example, the unplanted seeds may include a relative maturity within a threshold of planted seeds, and/or a relative maturity suited to a location of the field(s) of the grower.

It should be understood that the accessing of the data may include, optionally, filtering, based on the input from the user beyond merely limiting the data to a specific grower, or group of growers. For example, the data may be limited by region, where the grower(s) are associated with fields in more than one different region (e.g., state, territory, RM band, etc.).

At 516, then, the agricultural computer system 116 accesses data related to the identified seeds. The seed data may include, without limitation, trade or commercial name, brand, product identifier, ratings, trait stack(s), product category (e.g., product age, etc.), relative maturity, stalk strength, wilt, green snap, leaf blight, dry down, harvest appearance, emergence, root strength, test weight, seeding growth, leaf spot, stalk rot, drought tolerance, etc., which may be indicated in a data sheet for the specific seed and/or based on performance of the seed in the target field in one or more prior years. In general, for example, the accessed data for the seeds may include any data published by a provider and/or seller of the seeds (e.g., in a datasheet, or in a seed catalog, etc.), whereby data that a grower considered in selecting the seed, or even views in selecting a seed, is included.

In this example embodiment, at 518, the agricultural computer system 116 then identifies the candidate seeds based on the accessed data and the trained (and validated) model. In particular, the accessed data is exposed to the trained model, whereby the model, as trained, identifies which of the candidate seeds is consistent with the grower's preferences, as defined by the trained model. In connection therewith, the learned weights may provide inferences as to which seed attributes are more important to a given operation or feature. In turn, an inference may be made that a given product is recommended because of a good rating value on one or more important attributes/features.

Apart from the trained model, the agricultural computer system 116 may employ other processes and/or analysis to further identify the candidate seeds. For example, the agricultural computer system 116 may identify twenty candidate seeds through the trained model at 518, and then identify yield-based candidate seeds through another model or technique, and then cross-reference the candidate seeds. The agricultural computer system 116 may then proceed with only the candidate seeds identified by both the trained model and the yield-based model. It should be appreciated that other additional identification of seeds may be employed, which may be based on, for example, overall performance, the specific fields associated with the grower, the expected or desired yield, competitive seeds, etc.

Further, at 520 of FIG. 5, the agricultural computer system 116 outputs the identified candidate seeds to the user associated with the agricultural computer system 116. For example, the agricultural computer system 116 may output the set of candidate seeds to a sales representative associated with the grower and/or the target field, etc. The output may include an email, or presentation as part of an interface (e.g., a website, a web application, etc.). The user or grower may then coordinate planting one of the set of candidate seeds, along with the target seed, in the target field for a next growing season.

In turn, one (or more) seed(s) from the set of candidate seeds may be selected by the grower/user (e.g., the user 1002 in FIG. 1, etc.). For instance, the grower/use may order and/or purchase the selected candidate seeds, via the agricultural computer system 116, etc. (e.g., whereby the agricultural computer system 116 receives the order, purchase request, etc. from the grower/user, in response to the output of the candidate seeds to the grower/user and a corresponding selection by the grower/user; etc.), and then the agricultural computer system 116 may direct the selected seeds to the grower/user (e.g., deliver the selected seeds to the target field, etc.). In addition, the selected one of the set of candidate seeds may be planted, by the grower/user or other party, in the target field. In doing so, broadly, the selected candidate seeds are included (e.g., planted, etc.) in the target field, based on the selection described above. This may include the grower/user receiving the selected candidate seeds and operating a planter to plant the seeds in the target field. Alternatively, this may include the agricultural computer system 116 generating planting instructions based on the selected candidate seeds and providing the instructions to a planter whereby the planter automatically operates, in response to the instructions, to plant the selected candidate seeds in the target field (e.g., upon delivery of the seeds to the planter, etc.).

In some example embodiments, the identified candidate seeds may be presented (or output, etc.) together with seeds identified/selected via one or more other models (e.g., based on one or more other evaluations of the seeds with regard to performance, yield, etc.). In doing so, the identified candidate seeds herein may then also be presented with additional information regarding performance as determined by the other models. In this way, the seeds ultimately output may then include seeds that both perform well and are preferred by the grower/user.

With reference again to FIG. 1, the user 1002 (e.g., a grower, a sales representative, another user, etc.) in the system 100 may own, operate or possess a field manager computing device 1004 in a field location, or associated with a field location, such as the field 1005 intended for agricultural activities or a management location for one or more agricultural fields. The field manager computing device 1004 is programmed, or configured, to provide field data to the agricultural computer system 116 via one or more networks (as indicated by arrowed lines in FIG. 1) (e.g., for use in identifying characteristics of target field 1005, etc.). Again, the network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 108 is communicatively coupled to the agricultural computer system 116 and are programmed, or configured, to send external data (e.g., data associated with growing spaces 102-106, etc.) to agricultural computer system 116 via the network(s) herein (e.g., for use in identifying candidate seeds for the target field 1005 identified by the user 1002, etc.). The data server 108 may be owned or operated by the same legal person or entity as the agricultural computer system 116, or by a different person or entity, such as a government agency, non-governmental organization (NGO), and/or a private data service provider. Examples of external data include weather data, imagery data, soil data, seed data and seed selection data as described herein, data from the various growing spaces 102-106 herein, or statistical data relating to crop yields, among others. External data may include the same type of information as field data. In some embodiments, the external data may also be provided by data server 108 owned by the same entity that owns and/or operates the agricultural computer system 116. For example, the agricultural computer system 116 may include a data server focused exclusively on a type of data that might otherwise be obtained from third party sources, such as weather data. In some embodiments, data server 108 may actually be incorporated within the system 116.

The system 100 also includes, as described above, harvesting devices 106a-b configured to harvest seeds from one or more growing spaces (e.g., from field growing space 106, etc.). In some examples, the harvesting devices 106a-b may have one or more remote sensors fixed thereon, where the sensor(s) are communicatively coupled, either directly or indirectly, via the harvesting devices 106a-b to the agricultural computer system 116 and are programmed, or configured, to send sensor data to agricultural computer system 116.

Additional examples of agricultural apparatus that may be included in the system 100 include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts that are used to control an operating parameter of the agricultural apparatus (or another agricultural vehicle or implement) from the agricultural computer system 116 (e.g., planting instructions generated by the agricultural computer system 116 and transmitted to a planter agricultural apparatus that then control operation of the planter agricultural apparatus to plant certain selected seeds (e.g., in a particular manner, etc.), etc.). For instance, a controller area network (CAN) bus interface may be used to enable communications from the agricultural computer system 116 to the agricultural apparatus 106a and/or 106b, for example, such as how the CLIMATE FIELDVIEW DRIVE, available from Climate LLC, Saint Louis, Missouri, is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the harvesting devices 106a-b in the system 100, data server 108, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 116 is programmed, or configured, to receive field data from field manager computing device 1004, external data 1010 from data server 1008, and sensor data from one or more remote sensors in the system 100. Agricultural computer system 116 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 1032, a presentation layer 1034, a data management layer 1040, a hardware/virtualization layer 1050, and a model and field data repository 1060. “Layer,” in this context, refers to any combination of electronic digital interface circuits, microcontrollers, firmware, such as drivers, and/or computer programs, or other software elements.

Communication layer 1032 may be programmed, or configured, to perform input/output interfacing functions including sending requests to field manager computing device 1004, data server 108, and remote sensor(s) for field data, external data, and sensor data respectively. Communication layer 1032 may be programmed, or configured, to send the received data to model and field data repository 1060 to be stored as field data (e.g., in computer system 116, etc.).

Presentation layer 1034 may be programmed, or configured, to generate a graphical user interface (GUI) to be displayed on field manager computing device 1004 (e.g., for use in interacting with agricultural computer system to identify the target field 1005, target seed, etc.) or other computers that are coupled to the system 116 through the network(s). The GUI may comprise controls for inputting data to be sent to agricultural computer system 116, generating requests for models and/or recommendations, and/or displaying recommendations, notifications, models, and other field data.

Data management layer 1040 may be programmed, or configured, to manage read operations and write operations involving the repository layer 1060 and other functional elements of the system, including queries and result sets communicated between the functional elements of the system and the repository. Examples of data management layer 1040 include JDBC, SQL server interface code, and/or HADOOP interface code, among others. Repository layer 1060 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 116 via one or more agricultural machines or agricultural machine devices that interact with the agricultural computer system 116, the user 1002 may be prompted via one or more user interfaces on the device 1004 (served by the agricultural computer system 116) to input such information for use in effecting the selections herein. In an example embodiment, the user 1002 may specify identification data by accessing a map on the device 1004 (served by the agricultural computer system 116) and selecting specific CLUs that have been graphically shown on the map. In an alternative embodiment, the user 1002 may specify identification data by accessing a map on the device 1004 (served by the agricultural computer system 116) and drawing boundaries of the field over the map. Such CLU selection, or map drawings, represent geographic identifiers. In alternative embodiments, the user 1002 may specify identification data by accessing field identification data (provided as shape files or in a similar format) from the U.S. Department of Agriculture Farm Service Agency, or other source, via the device 1004 and providing such field identification data to the agricultural computer system 116.

In an example embodiment, the agricultural computer system 116 is programmed to generate and cause displaying of a graphical user interface comprising a data manager for data input. After one or more fields have been identified using the methods described above, the data manager may provide one or more graphical user interface widgets which when selected can identify changes to the field, soil, crops, tillage, or nutrient practices, and/or which may provide comparison data related to target seed identified by the user 1002 and candidate seeds identified by the disclosure herein for the target field 1005. The data manager may include a timeline view, a spreadsheet view, a graphical view, and/or one or more editable programs.

In an embodiment, model and field data is stored in model and field data repository layer 1060. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With reference again to FIG. 1, in an embodiment, instructions 1035 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 1035 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 1035 also may represent one or more files or projects of source code that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

Hardware/virtualization layer 1050 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 11. The layer 1050 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 1004 associated with different users. Further, the system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 1002 interacts with agricultural computer system 116 using field manager computing device 1004 configured with an operating system and one or more application programs or apps; the field manager computing device 1004 also may interoperate with the agricultural computer system 116 independently and automatically under program control or logical control and direct user interaction is not always required. Field manager computing device 1004 broadly represents one or more of a smart phone, PDA, tablet computing device, laptop computer, desktop computer, workstation, or any other computing device capable of transmitting and receiving information and performing the functions described herein. Field manager computing device 1004 may communicate via a network using a mobile application stored on field manager computing device 1004, and in some embodiments, the device may be coupled using a cable or connector to one or more sensors and/or other apparatus in the system 100. A particular user 1002 may own, operate or possess and use, in connection with system 100, more than one field manager computing device 1004 at a time.

The mobile application associated with the field manager computing device 1004 may provide client-side functionality, via the network to one or more mobile computing devices. In an example embodiment, field manager computing device 1004 may access the mobile application via a web browser or a local client application or app. Field manager computing device 1004 may transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 1004 which determines the location of field manager computing device 1004 using standard tracking techniques, such as multilateration of radio signals, the global positioning system (GPS), WiFi positioning systems, or other methods of mobile positioning. In some cases, location data or other data associated with the device 1004, user 1002, and/or user account(s) may be obtained by queries to an operating system of the device or by requesting an app on the device to obtain data from the operating system.

In an embodiment, in addition to other functionalities described herein, field manager computing device 1004 sends field data to agricultural computer system 116 comprising or including, but not limited to, data values representing one or more of: a geographical location of the one or more fields, tillage information for the one or more fields, crops planted in the one or more fields, and soil data extracted from the one or more fields. Field manager computing device 1004 may send field data in response to user input from user 1002 specifying the data values for the one or more fields. Additionally, field manager computing device 1004 may automatically send field data when one or more of the data values becomes available to field manager computing device 1004. For example, field manager computing device 1004 may be communicatively coupled to a remote sensor in the system 100, and in response to an input received at the sensor, field manager computing device 1004 may send field data to agricultural computer system 116 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 1004 may also be stored as external data (e.g., where the field data is collected as part of harvesting crops from growing spaces 102-106, etc.), for example, in data server 108.

A commercial example of the mobile application is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

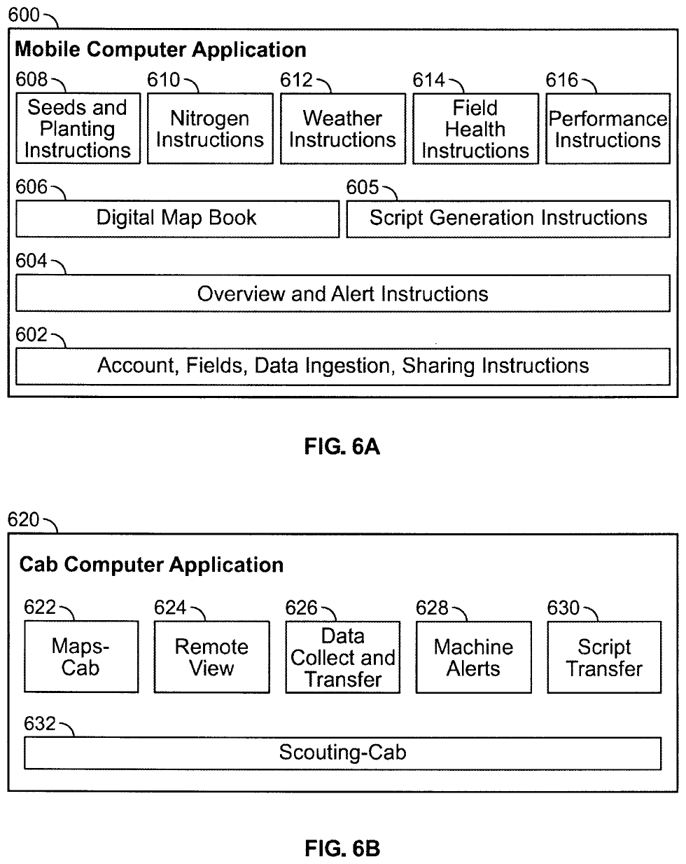

FIGS. 6A-6B illustrate two views of an example logical organization of sets of instructions in main memory when an example mobile application is loaded for execution. Each named element represents a region of one or more pages of RAM or other main memory, or one or more blocks of disk storage or other non-volatile storage, and the programmed instructions within those regions. In one embodiment, in FIG. 6A, a mobile computer application 600 comprises account-fields-data ingestion-sharing instructions 602, overview and alert instructions 604, digital map book instructions 606, seeds and planting instructions 608, nitrogen instructions 610, weather instructions 606, field health instructions 614, and performance instructions 616.

In one embodiment, a mobile computer application 600 comprises account, fields, data ingestion, sharing instructions 602 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 600 comprises a data inbox. In response to receiving a selection of the data inbox, the mobile computer application 600 may display a graphical user interface for manually uploading data files and importing uploaded files to a data manager.

In one embodiment, digital map book instructions 606 comprise field map data layers stored in device memory and are programmed with data visualization tools and geospatial field notes. This provides growers with convenient information close at hand for reference, logging and visual insights into field performance. In one embodiment, overview and alert instructions 604 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 608 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 605 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 600 may display one or more fields broken into management zones, such as the field map data layers created as part of digital map book instructions 606. In one embodiment, the management zones comprise soil zones along with a panel identifying each soil zone and a soil name, texture, drainage for each zone, or other field data. Mobile computer application 600 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 600 may make the script available for download in a format readable by an application controller, such as an archived or compressed format. Additionally, and/or alternatively, a script may be sent directly to a cab computer (e.g., associated with apparatus 106a and/or 106b, etc.) from mobile computer application 600 and/or uploaded to one or more data servers and stored for further use.

In one embodiment, nitrogen instructions 610 are programmed to provide tools to inform nitrogen decisions by visualizing the availability of nitrogen to crops. This enables growers to maximize yield or return on investment through optimized nitrogen application during the season. Example programmed functions include displaying images, such as SSURGO images, to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 600. For example, nitrogen instructions 610 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation, such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 610 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 610 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 610 could be used for application of other nutrients (such as phosphorus and potassium), application of pesticide, and irrigation programs.

In one embodiment, weather instructions 606 are programmed to provide field-specific recent weather data and forecasted weather information. This enables growers to save time and have an efficient integrated display with respect to daily operational decisions.

In one embodiment, field health instructions 614 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 616 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 616 may be programmed to communicate via the network(s) to back-end analytics programs executed at agricultural computer system 116 and/or data server 108 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer (e.g., associated with apparatus 106a and/or 106b, etc.). For example, referring now to FIG. 6B, in one embodiment a cab computer application 660 (e.g., as accessible in one of apparatus 106a, 106b, etc.) may comprise maps-cab instructions 662, remote view instructions 664, data collect and transfer instructions 666, machine alerts instructions 668, script transfer instructions 630, and scouting-cab instructions 632. The code base for the instructions of FIG. 6B may be the same as for FIG. 6A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 662 may be programmed to provide map views of fields, farms or regions that are useful in directing machine operation. The remote view instructions 664 may be programmed to turn on, manage, and provide views of machine activity in real-time or near real-time to other computing devices connected to the computer system 116 via wireless networks, wired connectors or adapters, and the like. The data collect and transfer instructions 666 may be programmed to turn on, manage, and provide transfer of data collected at sensors and controllers to the computer system 116 via wireless networks, wired connectors or adapters, and the like (e.g., via network(s) in the system 100, etc.). The machine alerts instructions 668 may be programmed to detect issues with operations of the machine or tools that are associated with the cab and generate operator alerts. The script transfer instructions 630 may be configured to transfer in scripts of instructions that are configured to direct machine operations or the collection of data. The scouting-cab instructions 632 may be programmed to display location-based alerts and information received from the computer system 116 based on the location of the field manager computing device 1004, harvesting devices 106a-b, or sensors in the field 1005 (or in the growing spaces 102-106) and ingest, manage, and provide transfer of location-based scouting observations to the computer system 116 based on the location of the harvesting devices 106a-b or sensors in the field 1005 (or in the growing spaces 102-106, etc.).

In an embodiment, data server 108 store external data 1010 from the data server 1008, including soil data representing soil composition for the one or more fields and weather data representing temperature and precipitation on the one or more fields. The weather data may include past and present weather data as well as forecasts for future weather data. In an embodiment, data server 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 108, again, may include data associated with the growing spaces 102-106 with regard to available seeds for use in comparisons, etc.

In an embodiment, remote sensors in the system 100 may comprises one or more sensors that are programmed, or configured, to produce one or more observations. Remote sensor may be aerial sensors, such as satellites, vehicle sensors, planting equipment sensors, tillage sensors, fertilizer or insecticide application sensors, harvester sensors, and any other implement capable of receiving data from the one or more fields (e.g., associated with one or more of the growing spaces 102-106, etc.). In an embodiment, harvesting devices 106a-b may include an application controller programmed, or configured, to receive instructions from agricultural computer system 116. The application controller may also be programmed, or configured, to control an operating parameter of the harvesting devices 106a-b. Other embodiments may use any combination of sensors and controllers, of which the following are merely selected examples.

The system 100 may obtain or ingest data under user 1002 control, on a mass basis from a large number of growers who have contributed data to a shared database system. This form of obtaining data may be termed “manual data ingest” as one or more user-controlled computer operations are requested, or triggered, to obtain data for use by the computer system 116. As an example, the CLIMATE FIELDVIEW application, commercially available from Climate LLC, Saint Louis, Missouri, may be operated to export data to computer system 116 for storing in the repository 1060.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100. Examples are disclosed in US Pat. No. 8,738,243 and US Pat. Pub. 201050094916, and the present disclosure assumes knowledge of those other patent disclosures.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosures.

In an embodiment, sensors and controllers may be affixed to soil sampling and measurement apparatus that is configured, or programmed, to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors and controllers may comprise weather devices for monitoring weather conditions of fields. For example, the apparatus disclosed in published international application WO2016/176355A1, may be used, and the present disclosure assumes knowledge of that patent disclosure.

In an embodiment, the agricultural computer system 116 is programmed, or configured, to create an agronomic model. In this context, an agronomic model is a data structure in memory of the agricultural computer system 116 that comprises field data, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 116 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

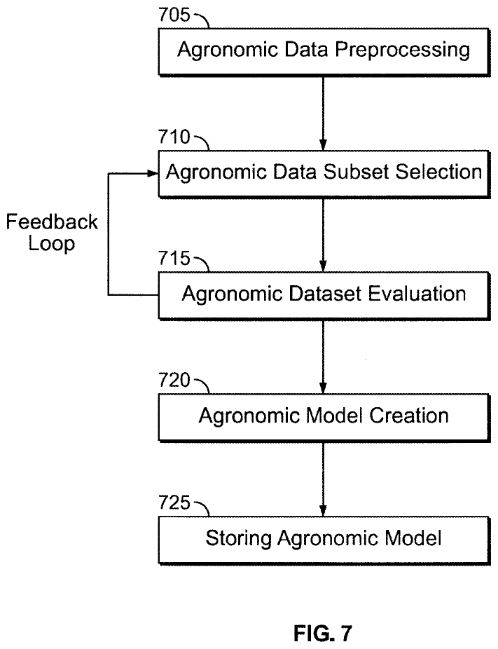

FIG. 7 illustrates a programmed process by which the agricultural computer system 116 generates one or more preconfigured agronomic models using field data provided by one or more data sources. FIG. 7 may serve as an algorithm or instructions for programming the functional elements of the agricultural computer system 116 to perform the operations that are now described.

At block 705, the agricultural computer system 116 is configured, or programmed, to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 710, the agricultural computer system 116 is configured, or programmed, to perform data subset selection using the preprocessed field data in order to identify datasets useful for initial agronomic model generation. The agricultural computer system 116 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 715, the agricultural computer system 116 is configured, or programmed, to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 710).

At block 720, the agricultural computer system 116 is configured, or programmed, to implement agronomic model creation based upon the cross validated agronomic datasets. In an embodiment, agronomic model creation may implement multivariate regression techniques to create preconfigured agronomic data models.

At block 725, the agricultural computer system 116 is configured, or programmed, to store the preconfigured agronomic data models for future field data evaluation.

According to one embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

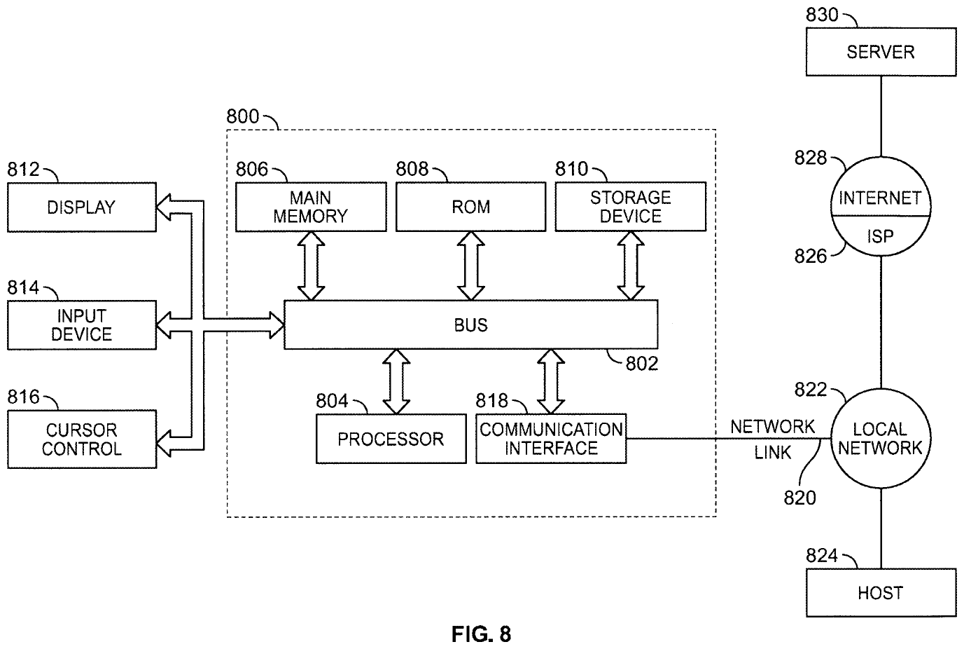

For example, FIG. 8 is a block diagram that illustrates a computer system 800 upon which embodiments of the present disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808, or other static storage device coupled to bus 802, for storing static information and instructions for processor 804. A storage device 810, such as a magnetic disk, optical disk, or solid-state drive, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x, etc.) and a second axis (e.g., y, etc.), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infrared data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infrared signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server might transmit a requested code for an application program through Internet 828, ISP 826, local network 822 and communication interface 818.

The received code may be executed by processor 804 as it is received, and/or stored in storage device 810, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) identifying multiple seeds for a grower, the multiple seeds suitable to be selected by the grower for planting in one or more growing spaces associated with the grower; (b) accessing data from a data server, the data including seed data representative of each of the multiple seeds; (c) identifying candidate seeds from the multiple seeds for the grower, based on a model specific to the grower, wherein the model is trained on historical selections of the candidate seeds by the grower and/or at least one other grower in a region of said grower, independent of historical performance of the candidate seeds in the one or more growing spaces associated with the grower; (d) outputting the identified candidate seeds to the grower and/or a user associated with the grower; (e) including, based on a selection by the grower, at least one seed from the identified candidate seeds in the one or more growing spaces; and/or (f) generating planting instructions for an agricultural planting apparatus, based on the identified candidate seeds, to plant at least one seed from the identified candidate seeds in the one or more growing spaces associated with the grower, whereby the agricultural planting apparatus operates to plant the at least one seed in the one or more growing spaces in response to the planting instructions.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying candidate seeds, the computer-implemented method comprising:
identifying, by a computing device, multiple seeds for a grower, the multiple seeds suitable to be selected by the grower for planting in one or more growing spaces associated with the grower;
accessing, by the computing device, data from a data server, the data including seed data representative of each of the multiple seeds;
identifying, by the computing device, candidate seeds from the multiple seeds for the grower, based on a model specific to the grower, wherein the model is trained on historical selections of the candidate seeds by the grower and/or at least one other grower in a region of said grower, independent of historical performance of the candidate seeds in the one or more growing spaces associated with the grower;
outputting, by the computing device, the identified candidate seeds to the grower or a user associated with the grower; and
including, based on a selection by the grower, at least one seed from the identified candidate seeds in the one or more growing spaces.

2. The computer-implemented method of claim 1, wherein the model is based, at least in part, on:
$$η = {c}_{op} + {\sum }_{features} {x}_{prod , feature} \cdot {w}_{op , feature}$$
$${c}_{op} = ( {μ}_{op} , {σ}_{c} )$$
$${w}_{op , feat} = ( {μ}_{op , feat} , {σ}_{feat} ) ;$$
wherein η is a per seed product, and cₒₚ is a feature agnostic probability of planting the seed with N as a normal distribution.

3. The computer-implemented method of claim 1, wherein the model is based, at least in part, on:
$$η = {c}_{op} + {\sum }_{features} {x}_{prod , feature , year} \cdot {w}_{op , feature} + {\sum }_{features} {x}_{prod , feature , year} \cdot {w}_{year , feature}$$
$${c}_{op} = ( {μ}_{op} , {σ}_{c} )$$
$${w}_{op , feat} = ( {μ}_{op , feat} , {σ}_{feat} )$$
$${w}_{year , feat} = ( {μ}_{year , feat} , {σ}_{year , feat} ) ;$$
wherein η is a per seed product, and cₒₚ is a feature agnostic probability of planting the seed with N as a normal distribution.

4. The computer-implemented method of claim 3, wherein the model is further based on:
$$p = \frac{1}{1 + {e}^{- η}}$$
$$Y ∼ Bernoulli ( p ) .$$

5. The computer-implemented method of claim 1, wherein the data representative of the multiple seeds includes, for each seed, one or more of: commercial name, brand, product identifier, ratings, trait stack(s), product category, relative maturity, stalk strength, wilt, green snap, leaf blight, dry down, harvest appearance, emergence, root strength, test weight, seeding growth, leaf spot, stalk rot, and/or drought tolerance.

6. The computer-implemented method of claim 1, further comprising receiving an input from the grower or the user associated with the grower prior to identifying the multiple seeds, the input indicative of the grower and a type of seed; and
wherein identifying the multiple seeds includes identifying the multiple seeds for the grower based on the type of seed indicated in the input.

7. The computer-implemented method of claim 1, further comprising training the model based, at least in part, on:
$$KL ( q ( Z ) ‖ P ( Z \vert X = D ) ) = - 𝔼 [ log ( \frac{P ( Z , X = D )}{q ( Z )} ) ] + log ( P ( X = D ) ) .$$

8. The computer-implemented method of claim 1, further comprising training the model, based on historical data specific to the grower, the historical data indicative of the historical selections of the candidate seeds by the grower.

9. The computer-implemented method of claim 8, further comprising:
identifying seeds planted by the grower in year Y as the historical selections of the candidate seeds by the grower;
accessing data for the historical selections of the candidate seeds by the grower from the data server;
identifying multiple unplanted seeds for the grower, based on the accessed data for the planted seeds;
accessing data for the identified unplanted seeds from the data server; and
joining the accessed data for the planted and unplanted seeds into a training data set for the grower; and
wherein training the model includes training the model based on at least a portion of the training data set.

10. The computer-implemented method of claim 9, wherein the accessed data for the planted and unplanted seeds includes, for each seed, one or more of: commercial name, brand, product identifier, ratings, trait stack(s), product category, relative maturity, stalk strength, wilt, green snap, leaf blight, dry down, harvest appearance, emergence, root strength, test weight, seeding growth, leaf spot, stalk rot, and/or drought tolerance.

11. The computer-implemented method of claim 1, further comprising training the model, based on historical data specific to the at least one other grower in a region of said grower, the historical data indicative the historical selections of the candidate seeds by the at least one other grower in a region of said grower.

12. The computer-implemented method of claim 1, further comprising selecting the at least one seed from the identified candidate seeds based on an input from the grower or the user associated with the grower; and
wherein including at least one seed from the identified candidate seeds in the one or more growing spaces includes planting the selected at least one seed in the one or more growing spaces.

13. A non-transitory computer-readable storage medium including executable instructions, which, when executed by at least one processor in connection with identifying a set of candidate seeds for a growing space, cause the at least one processor to:
identify multiple seeds for a grower, the multiple seeds suitable to be selected by the grower for planting in one or more growing spaces associated with the grower;
access data from a data server, the data including seed data representative of each of the multiple seeds;
identify candidate seeds from the multiple seeds for the grower, based on a model specific to the grower, wherein the model is trained on historical selections of the candidate seeds by the grower and/or at least one other grower in a region of said grower, independent of historical performance of the candidate seeds in the one or more growing spaces associated with the grower;
output the identified candidate seeds to the grower or a user associated with the grower; and
based on a selection of one(s) of the identified candidate seeds from the grower or the user associated with the grower, generate planting instructions for an agricultural planting apparatus to plant the one(s) of the identified candidate seeds in the one or more growing spaces associated with the grower, whereby the agricultural planting apparatus operates to plant the one(s) of the identified candidate seeds in the one or more growing spaces in response to the planting instructions.

14. The non-transitory computer-readable storage medium of claim 13, wherein the model is based, at least in part, on:
$$η = {c}_{op} + {\sum }_{features} {x}_{prod , feature} \cdot {w}_{op , feature}$$
$${c}_{op} = ( {μ}_{op} , {σ}_{c} )$$
$${w}_{op , feat} = ( {μ}_{op , feat} , {σ}_{feat} ) ;$$
wherein η is a per seed product, and cₒₚ is a feature agnostic probability of planting the seed with N as a normal distribution.

15. The non-transitory computer-readable storage medium of claim 13, wherein the model is based, at least in part, on:
$$η = {c}_{op} + {\sum }_{features} {x}_{prod , feature , year} \cdot {w}_{op , feature} + {\sum }_{features} {x}_{prod , feature , year} \cdot {w}_{year , feature}$$
$${c}_{op} = ( {μ}_{op} , {σ}_{c} )$$
$${w}_{op , feat} = ( {μ}_{op , feat} , {σ}_{feat} )$$
$${w}_{year , feat} = ( {μ}_{year , feat} , {σ}_{year , feat} ) ;$$
wherein η is a per seed product, and cₒₚ is a feature agnostic probability of planting the seed with N as a normal distribution.

16. The non-transitory computer-readable storage medium of claim 15, wherein the model is further based on:
$$p = \frac{1}{1 + {e}^{- η}}$$
$$Y ∼ Bernoulli ( p ) .$$

17. The non-transitory computer-readable storage medium of claim 13, wherein the data representative of the multiple seeds includes, for each seed, one or more of: commercial name, brand, product identifier, ratings, trait stack(s), product category, relative maturity, stalk strength, wilt, green snap, leaf blight, dry down, harvest appearance, emergence, root strength, test weight, seeding growth, leaf spot, stalk rot, and/or drought tolerance.

18. The non-transitory computer-readable storage medium of claim 13, wherein the executable instructions, when executed by the at least one processor, cause the at least one processor to receive an input from the grower or the user associated with the grower, the input indicative of the grower and a type of seed; and
identify the multiple seeds for the grower based on the type of seed indicated in the input.

19. The non-transitory computer-readable storage medium of claim 13, wherein the executable instructions, when executed by the at least one processor, further cause the at least one processor to train the model based, at least in part, on:
$$KL ( q ( Z ) ‖ P ( Z \vert X = D ) ) = - 𝔼 [ log ( \frac{P ( Z , X = D )}{q ( Z )} ) ] + log ( P ( X = D ) ) .$$

20. The non-transitory computer-readable storage medium of claim 13, wherein the executable instructions, when executed by the at least one processor, further cause the at least one processor to train the model, based on historical data specific to the grower, the historical data indicative of the historical selections of the candidate seeds by the grower.

21. The non-transitory computer-readable storage medium of claim 20, wherein the executable instructions, when executed by the at least one processor, further cause the at least one processor to:
identify seeds planted by the grower in year Y as the historical selections of the candidate seeds by the grower;
access data for the historical selections of the candidate seeds by the grower from the data server;
identify multiple unplanted seeds for the grower, based on the accessed data for the planted seeds;
access data for the identified unplanted seeds from the data server; and
join the accessed data for the planted and unplanted seeds into a training data set for the grower; and
wherein the executable instructions, when executed by the at least one process in connection with training the model, cause the at least one processor to train the model based on at least a portion of the training data set.

22. A system for use in identifying candidate seeds for a growing space, the system comprising at least one computing device configured to:
identify multiple seeds for a grower, the multiple seeds suitable to be selected by the grower for planting in one or more growing spaces associated with the grower;
access data from a data server, the data including seed data representative of each of the multiple seeds;
identify candidate seeds from the multiple seeds for the grower, based on a model specific to the grower, wherein the model is trained on historical selections of the candidate seeds by the grower and/or at least one other grower in a region of said grower, independent of historical performance of the candidate seeds in the one or more growing spaces associated with the grower;
output the identified candidate seeds to the grower or a user associated with the grower; and
based on a selection of one(s) of the identified candidate seeds from the grower or the user associated with the grower, generate planting instructions for an agricultural planting apparatus, based on the selection of the one(s) of the identified candidate seeds, to plant the one(s) of the identified candidate seeds in the one or more growing spaces associated with the grower, whereby the agricultural planting apparatus operates to plant the one(s) of the identified candidate seeds in the growing space in response to the planting instructions.

23. The system of claim 22, further comprising the one or more growing spaces in which the one(s) of the identified candidate seeds is (are) planted.

24. The system of claim 23, further comprising the agricultural planting apparatus configured to plant the one(s) of the identified candidate seeds in the one or more growing spaces based on the planting instructions.
